(19) United States
(12) Patent Application Publication
(10) Pub. No.: US 2020/0125515 A1
(43) Pub. Date: Apr. 23, 2020

(54) METHOD FOR RESOLVING AN ADDRESS CONFLICT FOR MODBUS RTU STANDARD PROTOCOL

(71) Applicant: Bender GmbH & Co. KG, Gruenberg (DE)

(72) Inventor: Matthias Jost, Lich (DE)

(21) Appl. No.: 16/655,397

(22) Filed: Oct. 17, 2019

(30) Foreign Application Priority Data
Oct. 18, 2018 (DE) 10 2018 125 894.1

(51) Int. Cl. G06F 13/362; G06F 11/10

(52) U.S. Cl. CPC G06F 13/362; G06F 11/1004

(57) ABSTRACT

The invention relates to a method for a master-slave communication using the Modbus RTU (Modbus Remote Terminal Unit) standard protocol for resolving an address conflict based on identically set device addresses and for identifying a device connected to the Modbus having a device identification. The addressed device is uniquely identified by means of its device identification, which is transmitted by the request, and a new device address is being transmitted to this uniquely identified device by means of the sent request. The fundamental concept of the present invention is advantageously based on using only the standard way of communication, meaning the standardized master-slave communication, for the assignment of a unique device address on the bus and on using the inherently existing device identification, such as the serial number (see below), for uniquely identifying a device.

This application claims the benefit of German Patent Application No. DE 10 2018 125 894.1, filed Oct. 18, 2018, the disclosure of which is incorporated herein by reference.

### TECHNICAL FIELD

The invention relates to a method for a master-slave communication using the Modbus RTU (Modbus Remote Terminal Unit) standard protocol for resolving an address conflict based on identically set device addresses and for identifying a device connected to the Modbus having a device identification.

### BACKGROUND

A request sent from the master has the following structure defined in the Modbus RTU specification: an address field for a device address, followed by a field for a function code, a data field and a CRC check field, wherein a starting register address for a starting register and a register number are indicated in the data field, which define a register area of registers directly succeeding each other starting from the starting register address.

The serial transmission according to Modbus RTU specification requires each device connected to the bus (bus user) to have a unique device address (bus address), via which the master can address the device. Each user must be assigned to a unique address within the range of 1 to 247. If two or more identical addresses are assigned, a corresponding number of devices are addressed by the same request of the master and send a reply. These simultaneous replies result in an address conflict on the bus which is merely detected because of the appearance of a transmission error. The master is unable to resolve the cause of the issue, namely the same device address being assigned multiple times.

Due to manufacturing reasons, it is advantageous for devices of the same type, such as sensors of a particular embodiment, to be delivered in an identically configured manner, especially since the address pool is merely provided with 247 addresses. As a result, identical device addresses are assigned multiple times if several of these devices are connected to a shared bus. As a requirement for an error-free transmission, the assignment of a unique bus address for each bus user is described in the Modbus RTU specification. It is, however, not mentioned, how such a unique assignment can be achieved.

Solutions for setting the device address by means of a bus command exist, but in this context, an address conflict is undetectable and unresolvable.

Up to now, the issue of the address conflict has been dealt with by assigning a device address to the respective bus user by means of a setting element in the commissioning phase, meaning before regular operation of the device, wherein the operator is responsible for this manual address assignment to be unique. Such a setting element can for example be realized as a sliding switch or a rotating switch. However, it can also be realized as a coding on, for example, a circuit board of the bus user or on a bus board, such that a device address is linked via the plug position.

Another option is to successively connect the bus users and to assign a new device address based on the known preset address in each case.

In addition, only one device at a time can be operated at a setup station and thus an address can be assigned via broadcast.

A further option is to unlock the bus user which is to receive a new bus address via a broadcast message for the implementation of this message by actuating a button or the like.

Furthermore, there are solutions available which use an additional signaling cable for signaling the automatic selection of a device address of a bus user.

Finally, the device address saved for a bus user can also be made available by means of additional hardware, for example via RFID (radio-frequency identification) or NFC (near-field communication).

All the options mentioned disadvantageously have in common that the assignment of the device address must either be realized and completed before regular operation of the device and/or that additional components or connection cables are required in most cases. Additionally, the setting elements of the device are often arranged in an inaccessible manner or are completely inaccessible, as with soldered or molded sensors, for example.

### SUMMARY

Therefore, the object of the present invention is to propose a method for a master-slave communication using the Modbus RTU standard protocol for resolving an address conflict which does not require additional hardware such as setting elements or signaling cables. The method aims to allow a conflict-free assignment of device addresses, even for devices arranged in an inaccessible manner.

This object is attained by uniquely identifying the device addressed by the device address indicated in the address field by means of the device identification, which is transmitted by the request, and by transmitting a new device address to this uniquely identified device by means of the sent request.

The fundamental concept of the present invention is advantageously based on using only the standard way of communication, meaning the standardized master-slave communication for the assignment of a unique device address on the bus and on using the inherently existing device identification, such as the serial number (see below), for uniquely identifying a device.

So if two or more devices connected to the bus have an identically set initial device address in the commissioning phase, a new unique device address is, according to the invention, assigned solely via the provided standardized master-slave communication, without requiring additional hardware.

The device's initial device identification for unique identification and the new device address are transmitted to the device by means of the request sent by the master.

In this context, the initial device address registered in the address field of the request can be assigned multiple times or this address registered in the address field can also be the broadcast address of the Modbus RTU standard protocol, such that several devices are addressed simultaneously but the address conflict is resolved due to the differentiation by means of the original device identification of each device.

In a further advantageous embodiment, the request comprises the Modbus RTU function code 0x10 for writing registers in the field for the function code, the device identification as a register content of the defined register area in the data field, the new device address as an additional register content of the defined register area in the data field, wherein the device, of which the device address matches the device address indicated in the address field and of which the device identification matches the device identification transmitted as a register content, takes over the device address as a new device address, said device address being transmitted as an additional register content.

The assignment of the new device address is therefore based on addressing the device in order to identify said device, starting from the specified Modbus RTU function code 0x10 for writing registers in the request, said addressing being expanded by the unique device identification. The expanded addressing is effected in such a matter that the device identification of the device and the new device address are transmitted in the data field of the request.

According to the invention, only the device of which the device identification is identical to the device identification communicated in the data field reacts to the request and takes over the transmitted device address as a new device address. Only this device takes over the communicated new device address as its new device address and replies to the request of the master according to Modbus RTU specification. The addressed device does not reply if the device identification is unequal.

A starting register content is advantageously defined as a selector, of which the selector value sets the function and processing of register contents of the defined register area, wherein the takeover of the new device address as a function to be performed in the identified device is assigned to a specified selector value.

The content of the starting register therefore illustrates a selector of which the value is responsible for deciding which function the register contents of the defined register area have and how these register contents are processed. Each function to be performed corresponds to a specified selector value in this context. In this way, the takeover of the new device address as set forth above can be assigned to the selector value 0x0000, for example, as a function to be performed in the identified device, such that when this value is transmitted and with the corresponding register contents, the execution of the processing steps for takeover of the new device address takes place.

Other selector values which cause an execution of additional functions (see below) in the identified device are also possible.

The defined register area preferably comprises the starting register having the selector value, N registers for the device identification and a register having the new device address to be assigned.

This specific allocation of the register area in the data field proves to be appropriate with respect to the number of possible selector values as well as with respect to the scope of the inherently existing device identifications and the number of specified device addresses according to Modbus RTU standard.

It is advantageous if the device identification is serial number of the device.

The serial number of the device is an appropriate choice for an initial device identification to uniquely identify the device connected to the Modbus, because it can be assumed that each device is engraved with such a unique serial number during the production process. In principle, however, it is possible to use any unique identification assigned to the device as a device identification.

In a preferred embodiment, each device addressed by the device address indicated in the address field replies to a request of the master for reading the device identification with a random delay time.

Besides the Modbus RTU function code 0x03 (read holding registers), other function codes can also be used as read requests for this purpose.

Each device addressed by the device address indicated in the address field replies within an individual randomly specified delay time in order to avoid a collision of the replies.

Advantageously, the random delay time as a multiple of a time slot duration is specified in such a manner that the replies of the devices occur without overlapping and in line with Modbus RTU.

The random delay time comprises multiple, for example 20, time slots, each having a time slot duration, said time slots being measured in such a manner that the reply to a read command can be sent error-free in line with Modbus RTU within the time slot duration. Due to the delay time which is based on the time slots, it can be avoided that the replies partly overlap, which in turn increases the likelihood of a reply being received by the master uninterrupted.

The minimum time slot duration is preferably specified in accordance with the N registers occupied by the device identification.

In this case, the duration of the time slot is chosen in such a manner that a device reply fits in a time slot in such a manner that a reply of an additional device in the time slot immediately following afterwards does not cause a violation of the idle time of 3.5 bytes transmission time specified in the Modbus RTU protocol (gap of the Modbus RTU requests).

In the present invention, in the case of a query regarding the device identification, which is, for example, assigned to N=2 of the defined register which is within the defined register area, the response length is 2*N+5=9 bytes, taking account of 5 offset bytes. A duration of 3.5+9+3.5=16 bytes transmission time can therefore be set as the minimum duration of the time slot. Thus, a minimum duration of the time slot of 14 bytes transmission time arises as a result for a device identification which is only assigned to one register (N=1).

It is also possible to transmit the device identification as an ASCII character set and to use N=10 register for this purpose, for example.

In case the reply to the request for reading the device identification is received without a CRC error, the device address is advantageously assigned.

If the master receives an error-free reply to its request for reading the device identification, it knows the unique device identification of a participating device. According to the invention, the master assigns a new bus address to said participating device.

Sending the request for reading the device identification and assigning a device address is advantageously executed in a cyclically repeated manner until a CRC error no longer occurs in the replies of the devices.

Sending the request for reading the device identification including the transmission of the device identification from the device to the master and the setting of a new device address according to the invention is cyclically repeated until a CRC error is no longer received in the replies of the respective devices. A conflict-free assignment to all devices connected to the Modbus can be realized in this manner.

An additional selector value is advantageously provided, which, as a function to be performed, causes a signal display on the device identified by means of the device identification.

A number of different selector values can be introduced which each result in a specified function or action being executed on the addressed device. It is therefore preferably also possible to perform a signal display on the addressed device as a function to be performed, wherein this identified device can be detected by means of an optical or acoustic signaling, for example. Such a signaling for identifying remotely arranged devices can be particularly helpful.

### BRIEF DESCRIPTION OF THE DRAWING FIGURES

Further advantageous embodiments can be derived from the following description and the drawings, which illustrate a preferred exemplary embodiment of the invention.

In the figures:

FIG. 1 a flowchart for a master-slave communication according to Modbus RTU standard protocol,

FIG. 2 structure and contents of a request for solving an address conflict according to the invention,

FIG. 3 a flowchart for resolving an address conflict according to the invention,

FIG. 4 structure and contents of a request for reading the device identification and

FIG. 5 a flowchart for reading the device identification, the reply having a random delay time.

### DETAILED DESCRIPTION

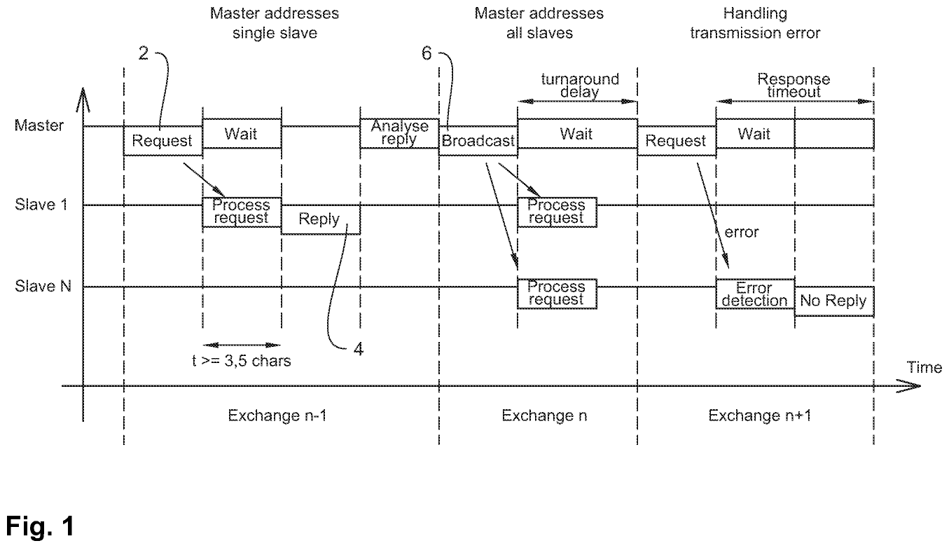

FIG. 1 illustrates a flowchart for a master-slave communication according to Modbus RTU standard protocol. The Modbus RTU standard protocol is based on a bus structure, in which all communication between a master and the devices connected to the bus (slaves) is controlled by the master. The master sends a request 2 to a specific device address, wherein only the device having this device address sends a reply 4 back to the master. A broadcast request 6, which is sent to all connected devices without expecting a reply is in this case regarded as an exception. If a device address was assigned multiple times, multiple devices reply simultaneously and the master detects a transmission error (CRC error).

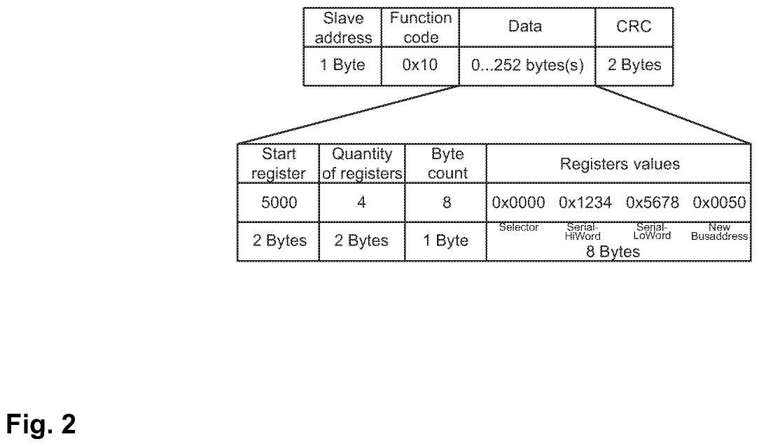

FIG. 2 illustrates the structure of a request according to Modbus RTU specification having a data assignment according to the invention for resolving an address conflict.

Besides the device address (slave address) of the device to be addressed, the request comprises the function code 0x10 (write multiple registers) which causes a writing of multiple registers in the address device. The data field comprises the information of a starting register, the number of registers or bytes, which the data filed comprises, and the contents of the registers, which are transmitted in the data field. Two bytes for CRC error detection form the end of the request.

The structure and content of a request are exemplary displayed having the following content:

Register assignment:

Register 5000 selector value

Register 5001/5002 serial number

Register 5003 new device address

This results in the Modbus RTU request for

Address: 0x64 address said to be assigned multiple times

Function code: 0x10 write multiple registers

Starting register: 0x1388 example: starting register 5000(=0x1388)

No. of registers: 4

No. of bytes: 8

Value 1.register: 0x0000 value register 5000, selector value 0000

Value 2.register: 0x1234 high-word of the serial number

Value 3.register: 0x5678 low-word of the serial number

Value 4.register: 0x50 new device address 80(=0x50)

All devices react to this request with the address 100 (0x64), but only the device with the device identification (serial number) 0x12345678 changes its device address to the new device address 80 (0x50).

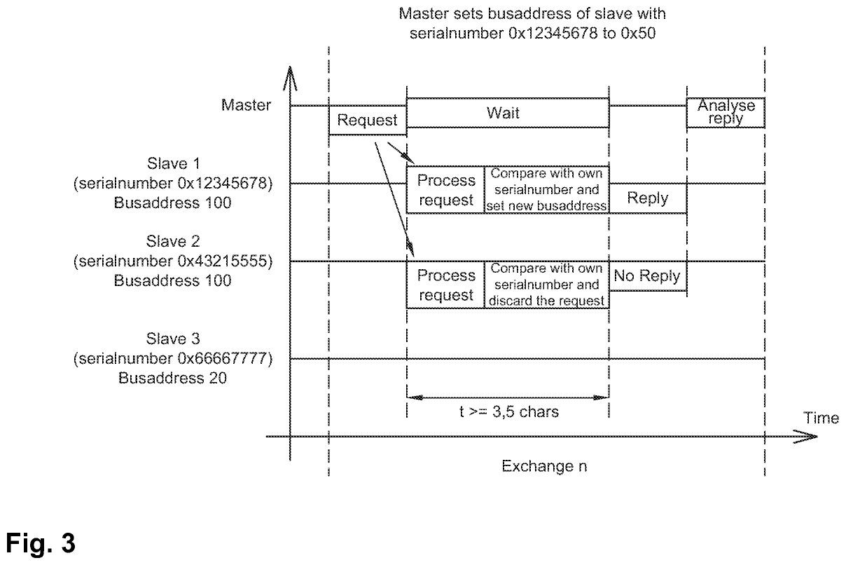

FIG. 3 illustrates the corresponding flow for solving the address conflict according to the invention in a flowchart.

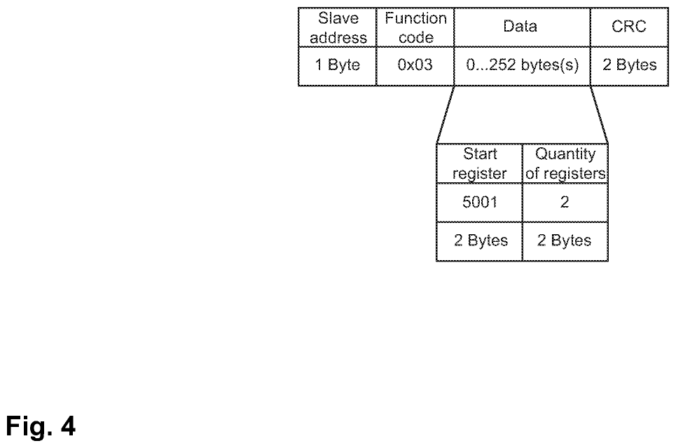

FIG. 4 illustrates the structure and content of a request for reading the device identification.

Reading the device identification in this case occurs according to Modbus RTU specification having the function code 0x03. The request and the reply of the device are in this case constructed as follows:

Register assignment: register 5001, 5002 serial number 0x12345678

Modbus RTU master request:

| | |
|---|---|
| Address: 0x64 | address said to be assigned multiple times |
| Function code: 0x03 | read multiple registers |
| Starting register: 0x1389 | example: starting register 5001 (= 0x1389) |
| No. of registers: 2 | |

Modbus RTU slave response:

Device (slave) determines a random time slot 0 . . . 19, e.g. 10

Device waits 10×15 ms=150 ms and then sends:

Address: 0x64

Function code: 0x03

Register content 1: 0x1234 (high-word own serial number)

Register content 2: 0x5678 (low-word own serial number)

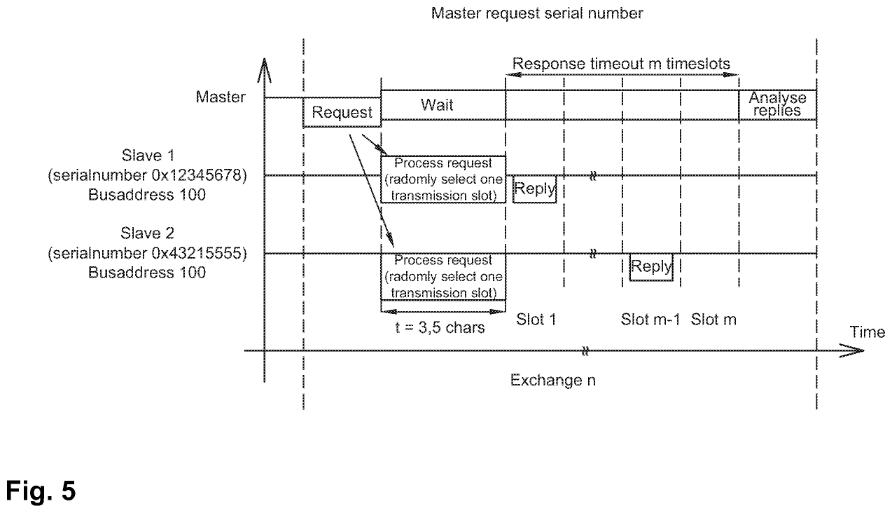

FIG. 5 illustrates a flowchart for reading the device identification, the reply having a random delay time.

It is illustrated how two devices having an identical device address but different device identifications reply to a request of the master for reading the device identification. It can initially be seen that both devices reply to the request of the master because they have the same addressed device address, however, they reply in different time slots. For the replies to be sent without overlapping and for no error message to occur, each device calculates an own random delay time for sending the respective reply.

The method for the assignment of a device address can therefore be repeatedly executed multiple times due to a further differentiation of a device by means of the unique device identification, resulting in all devices receiving a unique device address as bus users.

Despite an identical device address and an initially unknown device identification of the connected devices, this unique identification for each device can, however, be detected and the address conflict can subsequently be solved by addressing a new device address.

The method according to the invention is solely based on the standardized provided bus communication and refrains from using any additional auxiliary devices such as hardware for address setting (DIP switch, RFID, NFC, etc.) or additional signaling cables and is therefore particularly suitable for communication with devices such as sensors which are installed in an inaccessible manner.

1. A method for a master-slave communication using the Modbus RTU standard protocol for resolving an address conflict based on identically set device addresses and for identifying a device connected to the Modbus having a device identification, comprising the following steps:
sending a request comprising an address field for the device address, a field for a function code, a data field and a CRC check field from the master,
wherein a starting register address for a starting register and a register number, which define a register area of registers directly succeeding each other starting from the starting register address, are indicated in the data field,
wherein
the device addressed by the device address indicated in the address field is uniquely identified by means of the device identification, which is transmitted by the request, and
a new device address is transmitted to this uniquely identified device by means of the sent request.

2. The method according to claim 1,
wherein
the request comprises the Modbus RTU function code 0x10 for writing registers as a function code,
the request comprises the device identification as a register content of the defined register area in the data field,
the request comprises the new device address as an additional register content of the defined register area in the data field, and
the device, of which the device address matches the device address indicated in the address field and of which the device identification matches the device identification, which is transmitted as a register content, takes over the device address as a new device address, said device address being transmitted as an additional register content.

3. The method according to claim 2,
wherein
a starting register content is defined as a selector, of which the selector value sets the function and processing of register contents of the defined register area, wherein the takeover of the new device address as a function to be performed in the identified device is assigned to a specified selector value.

4. The method according to claim 3,
wherein
the defined register area comprises the starting register having the selector value, N registers for the device identification and a register having the new device address to be assigned.

5. The method according to claim 1,
wherein
the device identification is a serial number.

6. The method according to claim 1,
wherein
each device addressed by the device address indicated in the address field replies to a request of the master for reading the device identification with a random delay time.

7. The method according to claim 6,
wherein
the random delay time as a multiple of a time slot duration is specified in such a manner that the replies of the devices occur without overlapping and in line with Modbus RTU.

8. The method according to claim 7,
wherein
the minimum time slot duration is specified in accordance with the N registers, which are occupied by the device identification.

9. The method according to claim 6,
wherein
in case the reply to the request for reading the device identification is received without a CRC error, the device address is assigned according to claims 1 to 5.

10. The method according to claim 6,
wherein
sending the request for reading the device identification and assigning a device address is executed in a cyclically repeated manner until a CRC error no longer occurs in the replies of the devices.

11. The method according to claim 3,
wherein
an additional selector value is provided, which, as a function to be performed, causes a signal display on the device identified by means of the device identification.
